(19) United States
(12) Patent Application Publication
(10) Pub. No.: US 2017/0341282 A1
(43) Pub. Date: Nov. 30, 2017

(54) METHOD FOR MANUFACTURING A MULTILAYER PLASTIC LENS

(71) Applicant: GEBR. KRALLMANN GMBH, Hiddenhausen (DE)

(72) Inventor: Rainer KRALLMANN, Hiddenhausen (DE)

(73) Assignee: GEBR. KRALLMANN GMBH, Hiddenhausen (DE)

(21) Appl. No.: 15/536,360

(22) PCT Filed: Dec. 3, 2015
(86) PCT No.: PCT/EP2015/002431

§ 371 Date: Jun. 15, 2017

(30) Foreign Application Priority Data
Dec. 16, 2014 (DE) 10 2014 018 495.1

(51) Int. Cl. B29C 45/16; B29C 45/27; G02B 1/04; B29D 11/00; B29L 11/00; B29C 45/26

(52) U.S. Cl. CPC B29C 45/1679; G02B 1/041; B29D 11/00009; B29C 45/27; B29D 11/00423; B29C 45/1615; B29C 2045/2683; B29C 2045/1682; B29L 2011/00; B29L 2011/0016

(57) ABSTRACT

To form a multilayer plastic lens, a plurality of intermediate layers of a plastic material are injected one after another onto a basic part in an injection molding device in different cavities, wherein at least some of the cavities have a common first runner system with a common material feed. At least its [sic—“one”—“seine” is an obvious typo for “eine” meaning “one”—Tr.Ed.] outer layer consisting of a plastic material is then injected in a cavity by means of a second runner system, the second runner system having a material feed of its own and a control of its own.

### CROSS REFERENCE TO RELATED APPLICATIONS

This application is a United States National Phase Application of International Application PCT/EP2015/002431, filed Dec. 3, 2015, and claims the benefit of priority under 35 U.S.C. §119 of German Application 10 2014 018 495.1, filed Dec. 16, 2014, the entire contents of which are incorporated herein by reference.

### FIELD OF THE INVENTION

The present invention pertains to a method for manufacturing a multilayer plastic lens, wherein a plurality of intermediate layers of a plastic material are injected one after consecutively onto a basic element in different cavities in an injection molding device.

### BACKGROUND OF THE INVENTION

Attempts have been made for some time at manufacturing optical components, for example, a plastic lens, from a plastic instead of from glass, because plastic can be processed more easily and especially more cost-effectively. If, however, the optical component or the plastic lens has a relatively great thickness, as this happens, for example, in case of a biconvex lens, the problem may arise that mechanical damage as a consequence of thermal stresses and at least changes in the optical properties of the lens will occur during the cooling phase of the plastic, which takes place more rapidly in the outer and edge areas than in the core of the lens. For avoiding this, it is known that a corresponding lens can be composed of two layers applied consecutively from a uniform plastic material. For example, a basic element consisting of a plastic material is injected for this purpose into a first cavity. As soon as this basic element has a sufficient strength, the injection mold is opened and adjusted such that the basic element is arranged in a second cavity, in which a second layer of the plastic material is injected, and the first layer forming the basic element and the second layer injected onto it bind to form a uniform, monolithic component. A third layer, a fourth layer, etc., which all consist of the same plastic material, can be injected onto this in corresponding cavities in consecutive working steps.

It is especially difficult in this connection to achieve an economical continuous process, because the different layers have different sizes and thicknesses and thus consequently also require different solidification times and injection parameters. It was found that the manufacture of a multilayer, monolithic optical plastic lens is very time-consuming and hence cost-intensive.

### SUMMARY OF THE INVENTION

A basic object of the present invention is to provide a method for manufacturing a multilayer plastic lens, with which a corresponding plastic lens can be manufactured with high quality rapidly and in a cost-effective manner.

A plurality of intermediate layers of a plastic material are first injected consecutively onto a basic element in different cavities in an injection molding device, wherein at least some of the cavities have a common first runner system with a common material feed. The first runner system is usually a so-called hot runner system, as it is commonly used in the mechanical injection molding of plastics and especially thermoplastics and which is thermally insulated against the rest of the injection mold and is set at a higher temperature.

The present invention is based on the discovery that the process parameters with which the intermediate layers are applied or injected are not decisive for the optical properties of the plastic lens, but that it is essential for the optical properties of the plastic lens that the outer layer be formed and applied with optimized process parameters. Provisions are therefore made according to the present invention for injecting, after application of the intermediate layers, at least the outer layer from a plastic material in a cavity by means of a second runner system, which is likewise preferably a hot runner system. The second runner system has a material feed of its own (the second runner system has a material feed that is separate/different from that of the others) and a control of its own (the second runner system has a control that is separate/different from that of the others). Based on the material feed of its own and the control of its own of the second runner system, the process parameters with which the outer layer of the lens is injected can be set, on the one hand, accurately to the general process parameters, on the one hand, and, on the other hand, these process parameters can be set independently from the process parameters with which the intermediate layers and optionally the basic element are manufactured or injected.

Provisions are made in a preferred embodiment of the present invention for the control of the second runner system to have a temperature control device for the temperature of the plastic material fed and injected and/or a pressure control device, with which the pressure at which the plastic material is injected into the cavity can be set.

The plastic lens has a carrier-like basic part, onto which the intermediate layers are injected consecutively one on top of another in the cavities of the first runner system. The basic element may be prefabricated, but provisions are preferably made for it to be integrated in the manufacturing process and to be formed in a first step of the method in a cavity, which is preferably part of the first runner system. The basic part preferably consists here of the same plastic material as the intermediate layers, which are subsequently injected in the first runner system.

The intermediate layers may be injected onto the basic part on one side one after another and finally covered by the outer layer. Such a plastic lens is defined, on the one hand, by the basic part and, on the other hand, by the outer layer, which is arranged on the light entry side or on the light exit side depending on the direction in which the light enters.

It is possible, as an alternative, to inject at least some of the intermediate layers and preferably all intermediate layers in the form of two partial layers on respective opposite sides of the basic part or of a blank comprising the basic part and at least one intermediate layer. The first intermediate layer is injected onto the basic part from opposite sides. The second intermediate layer is also injected from opposite sides onto the preceding first intermediate layer formed in the preceding method step in a next method step. This procedure is performed until all intermediate layers will have been injected in the form of two partial layers on respective opposite sides onto the blank formed in the preceding method step. The outer layer is finally also injected in the second runner system from opposite sides onto the blank formed in the preceding method steps, which blank comprises the basic part and the intermediate layers injected on both sides, so that the plastic lens has a partial layer each of the outer layer on its light entry side and on its light exit side.

Provisions are made in a preferred embodiment of the present invention for all intermediate layers and optionally also the basic part to be injected or manufactured in the cavities of the first runner system and for only the outer layer of the plastic lens to be injected (on one side or on both sides) or manufactured in the second runner system.

It is, however, also possible as an alternative that the outer layer and at least one subjacent intermediate layer of the plastic lens to be injected by means of the second runner system.

The basic part, all intermediate layers and the outer layer preferably consist of the same plastic material, but it is also possible to form the outer layer from another or at least slightly modified plastic material.

An injection channel, through which the respective mass of the plastic material is inserted into the cavity, is preferably associated with each cavity. The pressure and/or the temperature of the plastic material can thus be controlled and set individually and independently from one another in at least some of the injection channels and preferably in all injection channels. Provisions may now be made for the masses of the plastic material inserted into the individual cavities of the first runner system to differ from one another by a maximum of ±10% and especially by a maximum of ±5% and especially preferably by only a maximum of ±1%. The basic consideration in this connection is that the volumes of the individual intermediate layers and hence the respective masses of the plastic material to be inserted to form the individual intermediate layers should be provided as equally as possible or at least with only small deviations. This makes it possible to form the intermediate layers in a continuous manufacturing process simultaneously in the first runner system, because the masses of plastic material necessary for the respective intermediate layers are very similar or identical or thus have similar or identical injection molding parameters and especially solidification times. Since the individual cavities possess different geometries, the insertion of the injected, liquid plastic material into the cavity can be achieved by controlling the injection pressure. Provisions may be made for this purpose according to the present invention for the pressure of the plastic material to be able to be controlled individually and independently from one another in at least some of the injection channels and especially in all injection channels of the first runner system, so that an optimized injection process is achieved.

A so-called revolver injection mold, in which two mold halves are rotatable in the opened position relative to one another and the respective partial cavities formed in the mold halves thus form the respective different cavities by different interactions, is preferably used for the method according to the present invention. A corresponding revolver injection mold is known from the multicomponent revolver injection molding method and is preferably used in connection with the method according to the present invention to make a blank for an optical plastic lens with thin intermediate layers of about 2 mm to 3 mm one after another from a single plastic material.

An outer layer is subsequently injected over the blank in the second runner system, the first runner system and the second runner system being able to be configured in a common injection mold, but independently from one another.

Provisions are made in a preferred embodiment of the present invention for the channels, which lead to the individual cavities of the first runner system, to be supplied with the plastic material from a common feed channel. The plastic material in the common feed channel is under a predefined pressure, which is preferably higher than the pressure with which the plastic material is injected into the individual cavities. The pressure reduction between the pressure in the feed channel and the injection pressure proper with which the plastic material is injected into the respective cavity is brought about by the pressure of the plastic material being reduced in the injection channels and adapted to the value optimal for the respective cavity or for the intermediate layer to be formed in that cavity. This can be achieved in a possible embodiment of the present invention by controlling the pressure of the plastic material in the cavities by reducing the pressure of the respective injection channel in which an adjustable throttle point is arranged, for example, in each injection channel.

Each layer has a larger surface than the layer located under it especially when a convex plastic lens is formed by consecutively applying different intermediate layers. If the plastic masses available for forming the individual intermediate layers are equal or at least approximately equal, the layers will vary. It proved to be advantageous in this case if provisions are preferably made according to the present invention for the individual intermediate layers of the plastic lens to be configured with different layer thicknesses, the thickness of the (n+1)th layer being smaller than the layer thickness of the nth layer formed before it.

Further details and features of the present invention appear from the following description of exemplary embodiments with reference to the drawings.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic cross sectional view through a plastic lens composed layer by layer according to a first exemplary embodiment;

FIG. 2 is a schematic cross sectional view through a plastic lens composed layer by layer according to a second exemplary embodiment;

FIG. 3 is a schematic view of an injection molding device for manufacturing a multilayer plastic lens according to the method according to the present invention; and

FIG. 4 is a variant of the injection molding device according to FIG. 3.

### DESCRIPTION OF THE PREFERRED EMBODIMENTS

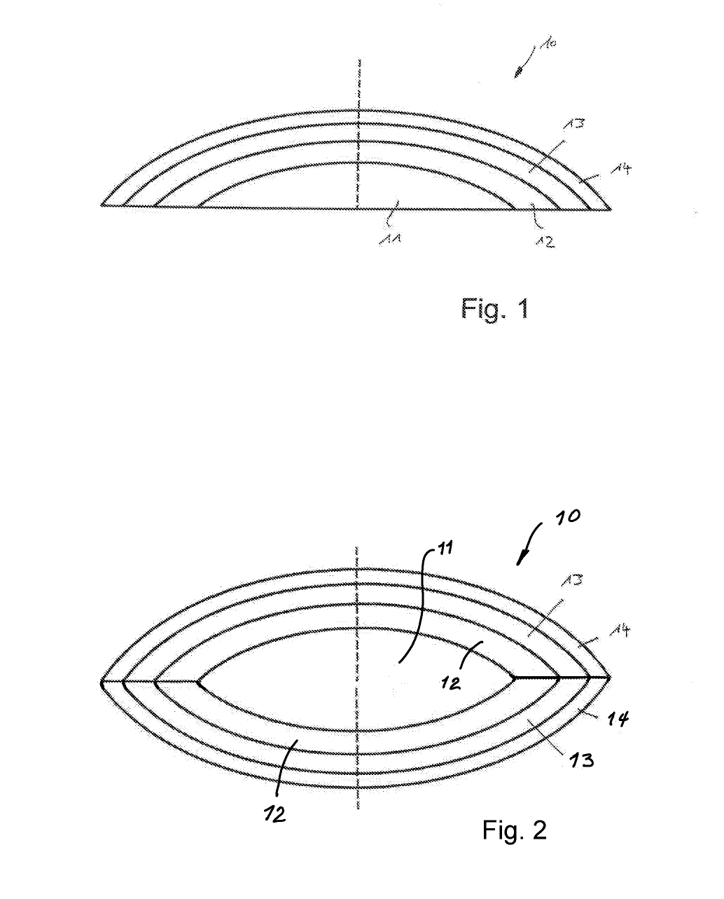

Referring to the drawings, FIG. 1 shows a cross section through a multilayer plastic lens 10 according to a first exemplary embodiment. The plastic lens 10 has a carrier-like basic part 11, on which a plurality of layers arranged one on top of another are applied. A first intermediate layer 12 is injected on one side onto the basic part 11. A second intermediate layer 13, which is covered by a third intermediate layer, is applied to the first intermediate layer 12. A fourth intermediate layer is, in turn, applied to this third intermediate layer. An outer layer 14, which covers all intermediate layers 12, 13, etc. and which passes smoothly over into the basic part 11, is finally applied. All layers consist of the same plastic material, so that a monolithic body consisting of a uniform material, which body was composed layer by layer, is formed.

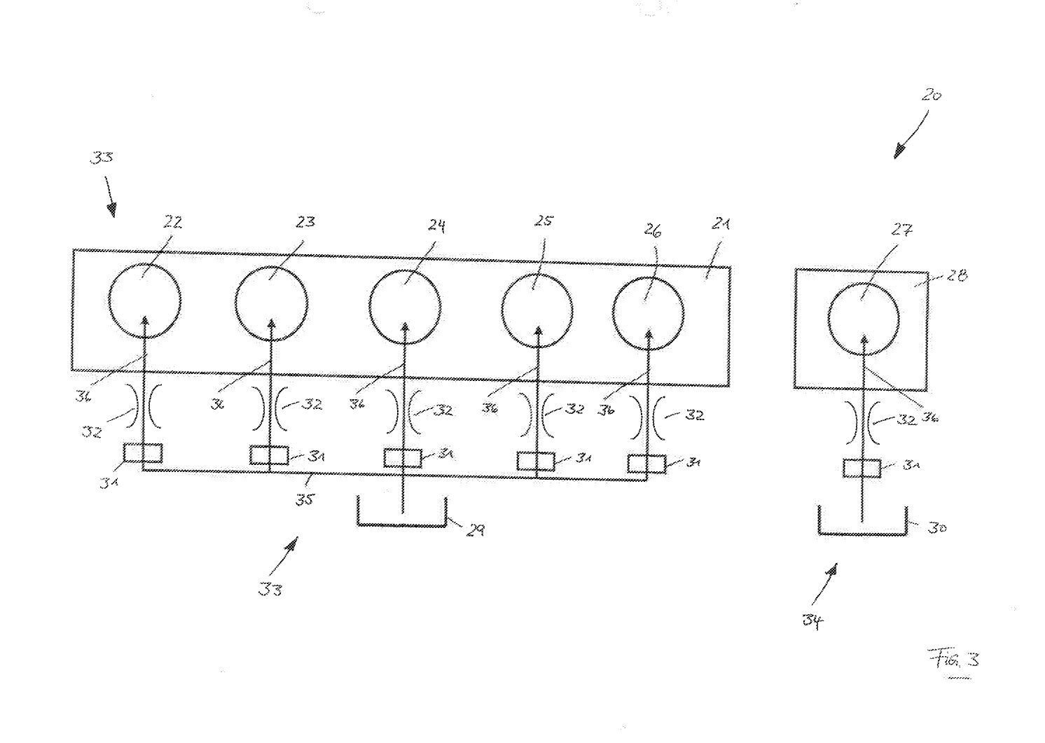

According to FIG. 1, all layers are applied to the basic part 11 on one side only, so that the plastic lens 10 is defined in its finished state by the basic part 11, on the one hand, and by the outer layer 14, on the other hand. FIG. 2 shows a modified exemplary embodiment, in which the layers are applied to the basic part 11 on both sides. As in the first exemplary embodiment, a carrier-like basic part 11, which is provided with the plastic material of the first intermediate layer 12 on both sides in a first step, is provided in the exemplary embodiment of the plastic lens 10, which exemplary embodiment is shown in FIG. 2. These partial layers of the first intermediate layer 12, which are arranged on opposite sides of the basic part 11, are covered with respective corresponding partial layers of the second intermediate layer 13. The partial layers of the third intermediate layer and of the intermediate layer are subsequently applied on both sides. The outer layer 14 is finally injected onto both sides of the blank formed from the basic part 11 and the intermediate layers, so that the plastic lens 10 is provided on both sides of the basic part 11 by a layer comprising four intermediate layers 12, 13, etc. and an outer layer 14 covering it on the outside.

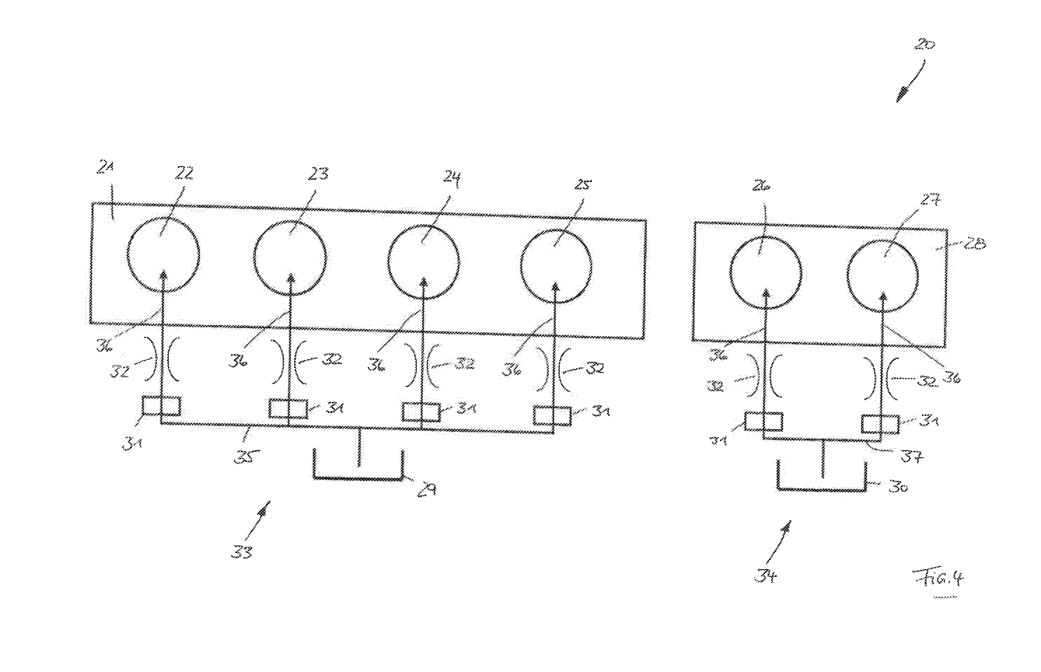

FIG. 3 shows a schematic view of an injection molding device 20, with which a plastic lens 10 according to FIG. 1 and FIG. 2 can be manufactured according to the method according to the present invention. The injection molding device 20 comprises a mold part 21, in which a plurality of cavities, namely, a first cavity 22, a second cavity 23, a third cavity 24, a fourth cavity 24 and a fifth cavity 26, are formed. The cavities are arranged in a row next to one another in the exemplary embodiment shown, but it is also possible and even preferred to arrange the cavities distributed over the circumference of a rotatable mold part.

To manufacture plastic lenses, the cavities are closed by means of an additional mold part, not shown, in the usual manner, and the same plastic material is inserted simultaneously in a so-called shot into all cavities 22, 23, 24, 25, 26. The injection molding device 20 comprises a first runner system 33 and a second runner system 34, which is fully independent therefrom, the runner systems preferably being so-called hot runner systems. The first runner system 33 comprises the cavities 22, 23, 24, 25 and 26 of the mold part 21.

The plastic material is located in a plastic supply 29, which is also suggested, and from which a common feed channel 35 leads to the cavities 22, 23, 24, 25, 26. A separate injection channel 36 branches off to each cavity from the feed channel 35. A pressure control device 32 in the form of an adjustable throttle point is arranged in each injection channel 36. In addition, a temperature control device 31, with which the temperature of the plastic material in the respective injection channel 36 can be controlled, is arranged in each injection channel 36.

The injection molding device 20 further comprises the second runner system 34, which has a sixth cavity 27, which is formed in a mold part 28 and into which the plastic material can be inserted from a plastic supply 30 via an injection channel 36. A temperature control device 31 and a pressure control device 32 are likewise arranged in the injection channel 36.

The first runner system 33 and the second runner system 34 may be configured in a common injection mold, but it is also possible to provide a separate injection mold for each runner system, but it is essential that the runner systems 33 and 34 be able to be actuated and operated independently from one another.

The method according to the present invention for manufacturing a plastic lens will be explained below in detail on the basis of FIG. 3.

The plastic material is injected during a starting phase of the manufacturing process into the first cavity 22 of the first runner system 23 only, while the other cavities are still closed. The carrier-like basic part 11 is formed in the first cavity 22. The mold is then opened and the mold parts are adjusted relative to one another such that the basic part 11 formed previously in the first cavity 22 is now located in the second cavity 23. After closing the mold parts, the plastic material is injected into the second cavity 23, as a result of which the first intermediate layer 12 is injected (on one side or on two sides) onto the basic part 11, as a result of which a so-called first blank is formed. At the same time, the plastic material is also injected, in turn, into the first cavity 22, as a result of which an another basic part 11 is formed. The other cavities are still closed now.

The mold parts are then opened again and adjusted relative to one another, so that the first blank comprising the basic part 11 and the first intermediate layer 12 is arranged now in the third cavity and the basic part 11 formed previously in the first cavity 22 is arranged now in the second cavity 23. The mold parts are closed again, and the plastic material is injected into the first, second and third cavities 22, 23 and 24. Another basic part 11 is formed now in the first cavity 22. A first intermediate layer 12 is injected in the second cavity 23 onto the basic part 11 formed previously, and a second intermediate layer 13 is injected in the third cavity onto the first blank having the basic part 11 and the first intermediate layer 12, as a result of which a so-called second blank is formed. The fourth cavity 25 and the fifth cavity 26 are still closed now.

The mold parts are subsequently opened again and adjusted relative to one another, so that the second blank comprising the basic part 11, the first intermediate layer 12 and the second intermediate layer 13 is then arranged in the fourth cavity 25. At the same time, a first blank, which was manufactured before in the cavity 23 and which comprises the basic part 11 and the first intermediate layer 12, is located in the third cavity 24. A basic part 11 formed previously in the first cavity 22 is located in the second cavity 23. The mold parts are closed again and the plastic material is injected into the cavities. The method is continued correspondingly.

A blank is formed in this manner within five method steps in the first runner system 33, said blank having the carrier-like basic part 11, on which four intermediate layers 12, 13, etc. are arranged one on top of another and overlapping each other on one side according to FIG. 1 or on both sides according to FIG. 2, the part 11 and all intermediate layers 12, 13, etc. consisting of the same plastic material. In a next method step, this blank is removed from the first runner system 33 and inserted into the sixth cavity 27 of the second runner system 34 and an outer layer 14 is injected over it either on one side according to FIG. 1 or on both sides according to FIG. 2, the plastic material used for the outer layer 16 being taken from the plastic supply 30 of the runner system 34. The plastic material may be the same plastic material as that of the first runner system 33 or also a plastic material that is different therefrom.

After application of the outer layer, the injection process is concluded and the plastic lens is manufactured layer by layer, and possible finishing operations may be performed in the usual manner.

The layers forming the plastic lens are bonded into a monolithic, one-piece body, on which no boundary surfaces can be seen between the layers.

Since the outer layer 16 is manufactured in a separate second runner system 34, the process parameters effective for the manufacture of the outer layer 16 can be optimally adapted to the requirements of the outer layer 16, while the basic part 11 and the intermediate layers are manufactured in the first runner system 33 with a constellation of parameters that makes possible the rapid manufacture of the blank with good quality.

FIG. 4 shows an injection molding device 20 in the form of a variant of the injection molding device according to FIG. 3. The injection molding device 20 according to FIG. 4 differs from the injection molding device according to FIG. 3 in that both the last intermediate layer and the outer layer 14 are formed one after another in the second runner system 34, while only the basic part 11 and the three intermediate layers 12, 13, etc are formed in the first runner system 33. Both the fifth cavity 26 and the sixth cavity 27, which can be supplied with plastic material from the plastic supply 30 via a feed channel 37 and an injection channel 36 each, are formed for this purpose in the mold part 28 of the second runner system 34. A temperature control device 31 and a pressure control device 32 are provided in each injection channel 36 in the manner mentioned. The blank to be transferred between the first runner system 33 and the second runner system 34 comprises in this case the carrier-side basic part 11 as well as three intermediate layers 12, 13, etc. applied on one side according to FIG. 1 or on two sides according to FIG. 2. After the transfer of the blank into the second runner system 34, the last intermediate layer is injected there in the fifth cavity, after which the outer layer 14 is injected in the sixth cavity 27 in another method step.

While specific embodiments of the invention have been shown and described in detail to illustrate the application of the principles of the invention, it will be understood that the invention may be embodied otherwise without departing from such principles.

1. A method for manufacturing a multilayer plastic lens, the method comprising the steps of:
injecting a plurality of intermediate layers of a plastic material onto a basic part in an injection molding device in different cavities;
providing at least some of the different cavities with a common first runner system with a common material feed
subsequently injecting at least one outer layer with a plastic material, in another cavity with a second runner system;
providing an injection channel, through which the plastic material is injected into the respective cavity, with each respective cavity;
providing the second runner system with a material feed that is different from the common material feed;
providing the second runner system with a control that is different from one or more control of the first runner system; and
controlling pressures and the temperatures of the plastic material independently from one another in at least some of the injection channels.

2. A method in accordance with claim 1, wherein the control of the second runner system has a temperature control device or a pressure control device or both a temperature control device and a pressure control device.

3. A method in accordance with claim 1, wherein only the outer layer of the plastic lens is injected by means of the second runner system.

4. A method in accordance with claim 1, wherein the outer layer and at least one intermediate layer of the plastic lens, which at least one intermediate layer is located under the outer layer, are injected by means of the second runner system.

5. A method in accordance with claim 1, wherein the basic part is manufactured in a first step in the injection molding device in another cavity.

6. A method in accordance with claim 5, wherein the other cavity forming the basic part is a part of the first runner system.

7. A method in accordance with claim 1, wherein the basic part and the intermediate layers consist of the same plastic material.

8. A method in accordance with claim 1, wherein the outer layer consists of the same plastic material as the intermediate layers.

9. A method in accordance with claim 1, wherein at least some of the intermediate layers or the outer layer are injected in the form of two partial layers on opposite sides of the basic part or of a blank comprising the basic part and at least one intermediate layer.

10. (canceled)

11. A method in accordance with claim 1, wherein the masses of the plastic material inserted into the individual cavities of the first runner system differ from one another by a maximum of ±10%.

12. A method in accordance with claim 11, wherein the masses of the plastic material inserted into the individual cavities differ one another by a maximum of ±5%.

13. A method in accordance with claim 12, wherein the masses of the plastic material inserted into the individual cavities differ from one another by a maximum of ±1%.

14. A method in accordance with claim 1, wherein the pressures are controlled independently from one another in all injection channels.

15. A method in accordance with claim 1, wherein the individual intermediate layers of the plastic lens are formed with different layer thicknesses, wherein the layer thickness of an (n+1)th layer formed is smaller than a layer thickness of an nth layer formed previously.
